(19) United States
(12) Patent Application Publication
(10) Pub. No.: US 2010/0299708 A1
(43) Pub. Date: Nov. 25, 2010

(54) METHOD AND APPARATUS FOR TRANSMITTING AND RECEIVING MULTI-FORMAT DIGITAL BROADCASTS

(75) Inventors: Yiling XU, Suwon-si (KR); Hong Sil Jeong, Seoul (KR); Jae Yeol Kim, Suwon-si (KR); Jae Yeon Song, Seoul (KR)

Correspondence Address: THE FARRELL LAW FIRM, LLP, 290 Broadhollow Road, Suite 210E, Melville, NY, 11747, US

(73) Assignee: Samsung Electronics Co., Ltd.

(21) Appl. No.: 12/784,071

(22) Filed: May 20, 2010

(30) Foreign Application Priority Data
May 20, 2009 (KR) 10-2009-0043937

(51) Int. Cl. H04N 5/445

(52) U.S. Cl. 725/54; 348/473

(57) ABSTRACT

A method and apparatus for transmitting and receiving multi-format digital broadcasts are disclosed. The method of transmitting multi-format digital broadcasts, includes creating digital broadcast services having different formats and electronic service guides (ESG) associated with the digital broadcast services; creating entry information for accessing the ESGs; and transmitting the digital broadcast services, the ESGs, and the entry information. The same broadcast services may be provided in multiple formats, and a broadcast receiver may selectively receive a broadcast service having a supportable format. Hence, it is possible to enhance effectiveness in reception of a digital broadcast service.

### PRIORITY

This application claims priority under 35 U.S.C. §119 to Korean Patent Application No. 10-2009-0043937, which was filed in the Korean Intellectual Property Office on May 20, 2009, the contents of which are incorporated herein by reference.

### BACKGROUND OF THE INVENTION

1. Field of the Invention

The present invention relates generally to a digital broadcast service and, more particularly, to a method and apparatus that can provide the same broadcast services in multiple formats.

2. Description of the Related Art

In general, broadcast services are provided to all users carrying broadcast receivers. Broadcast services may be categorized into audio broadcast services including only audio such as radio broadcasting, video broadcast services including audio and video such as TV broadcasting, and multimedia broadcast services including audio, video and data. With the rapid advancement of technology, existing analog broadcast services have evolved into digital broadcast services. Traditional broadcast services may be distributed through transmitting towers, and high quality and high-speed multimedia services including data may be distributed through wired networks, satellites, or both.

Mobile communication industries continuously create new services through recombination or synthesis of existing technologies, and have started to provide broadcast services to portable or mobile terminals (such as cellular phones and personal digital assistants) using existing broadcast systems or mobile communication systems.

The convergence of mobile communication services and Internet Protocol (IP) has become a mainstream trend for next generation mobile communication technologies as a result of the combination of various interests originating from potential and actual market needs, rapidly growing user need for multimedia services, business strategy aiming at providing new services such as broadcast services in addition to existing voice services, and information technology companies boosting the mobile communication business to meet user needs. This has stimulated the introduction and application of various services that have originated from the wireless broadcasting industry to the mobile communication industry and wired broadcasting industry, and such multi-directional convergence has created the same consumption environment for different broadcast services regardless of wired and wireless broadcasting.

FIG. 1 illustrates an architecture model for the Convergence of Broadcast and Mobile Services (CBMS) including a network providing digital broadcast services and a terminal.

In FIG. 1, Content Creation 101 acts as a content provider, and may provide content for a broadcast service. The content may be film, audio, and video data.

Service Application 103 aggregates content and related metadata from multiple sources (such as Content Creation 101) in order to provide a particular service application.

Service Management 105 may be composed of several sub-entities that manage individual services in desired manners.

Broadcast Network 107 and Interactive Network 109 act as a transmission-bearer for CBMS.

Terminal 111 receives service and signaling information through Broadcast Network 107, and performs bi-directional communication through Interactive Network 109.

CBMS-x and X-x denote reference points between different functional entities. CBMS-x refers to a reference point in the scope of IP Datacast according to DVB-H specifications, and X-x refers to a reference point out of the scope of IP Datacast according to DVB-H specifications.

The transmitting end may send digital broadcast services in various formats to the receiving end. For proper operation, the format of a broadcast service has to be agreed upon in advance between the transmitting and receiving ends.

In digital broadcasting, audio and video data may be broadcast in various screen formats. For example, a digital broadcast service may be provided in HDTV (High Definition TV) format or SDTV (Standard Definition TV) format, or, possibly, in other formats depending on picture quality and screen resolutions. Picture quality may broadly be determined by the number of pixels. The HDTV format may have 1920 (horizontal)*1080 (vertical) pixels (about two million pixels), and the existing SDTV format may have about 400,000 pixels (⅕ of the pixels of HDTV format). Other formats may be specified according to screen resolutions.

It may be difficult for a single digital broadcast receiver or terminal to support all known formats, and most digital broadcast receivers have limitations in terms of which formats they can support. Hence, it is necessary to develop a digital broadcast service method that can provide the same services in multiple formats.

### SUMMARY OF THE INVENTION

The present invention has been made in view of the above problems, and the present invention provides a method and apparatus that can provide the same broadcast services in multiple formats in a mobile broadcasting system.

In accordance with an embodiment of the present invention, there is provided a method of transmitting multi-format digital broadcasts, including creating digital broadcast services having different formats and Electronic Service Guides (ESG) associated respectively with the digital broadcast services; creating entry information for accessing the ESGs; and transmitting the digital broadcast services, the ESGs, and the entry information. The entry information may contain links referring respectively to the ESGs. The method may further include transmitting ESG Bootstraps (ESG BS) associated respectively with the ESGs, and the entry information may contain ESG BS entry points as links referring respectively to the ESG BSs.

In accordance with another embodiment of the present invention, there is provided a method of receiving multi-format digital broadcasts, including receiving digital broadcast services having different formats, ESGs associated respectively with the digital broadcast services, and entry information for accessing the ESGs; selecting one of the ESGs associated with a desired format utilizing the received entry information; and playing back one of the digital broadcast services associated with the selected ESG. The entry information may contain links referring respectively to the ESGs. The method may further include receiving ESG bootstraps (ESG BS) associated respectively with the ESGs, and the entry information may contain ESG BS entry points as links referring respectively to the ESG BSs.

In accordance with another embodiment of the present invention, there is provided an apparatus for transmitting multi-format digital broadcasts, including a service guide provisioning application creating digital broadcast services having different formats, creating Electronic Service Guides (ESG) associated respectively with the digital broadcast services, and creating entry information for accessing the ESGs; and a communication means for transmitting the digital broadcast services, the ESGs, and the entry information. The entry information may contain links referring, respectively, to the ESGs. The communication means may transmit ESG Bootstraps (ESG BS) associated respectively with the ESGs, and the entry information may contain ESG BS entry points as links referring respectively to the ESG BSs.

In accordance with another embodiment of the present invention, there is provided an apparatus for receiving multi-format digital broadcasts, including a receiver receiving digital broadcast services having different formats, ESGs associated respectively with the digital broadcast services, and entry information for accessing the ESGs; and a content consumption unit selecting one of the ESGs associated with a desired format utilizing the received entry information, and playing back one of the digital broadcast services associated with the selected ESG. The entry information may contain links referring, respectively, to the ESGs. The receiver may receive ESG Bootstraps (ESG BS) associated respectively with the ESGs, and the entry information may contain ESG BS entry points as links referring respectively to the ESG BSs.

In an embodiment of the present invention, the same broadcast services may be provided in multiple formats, and a broadcast receiver may selectively receive a broadcast service having a supportable format. Hence, it is possible to enhance the effectiveness in reception of a digital broadcast service.

### BRIEF DESCRIPTION OF THE DRAWINGS

The features and advantages of the present invention will be more apparent from the following detailed description in conjunction with the accompanying drawings, in which:

FIG. 1 illustrates an architecture model for Convergence of Broadcast and Mobile Services (CBMS) including a network providing digital broadcast services and a receiving terminal;

FIG. 2 illustrates a method for digital broadcast transmission according to an embodiment of the present invention;

FIG. 3 illustrates a method for digital broadcast reception in relation to the transmission method of FIG. 2;

FIG. 4 illustrates a signaling procedure for the methods of FIGS. 2 and 3;

FIG. 5 is a flow chart illustrating the transmission method of FIG. 2;

FIG. 6 is a flow chart illustrating the reception method of FIG. 3;

FIG. 7 illustrates a method for digital broadcast transmission according to another embodiment of the present invention;

FIG. 8 illustrates a method for digital broadcast reception in relation to the transmission method of FIG. 7;

FIG. 9 illustrates a signaling procedure for the methods of FIGS. 7 and 8;

FIG. 10 is a flow chart illustrating the transmission method of FIG. 7;

FIG. 11 is a flow chart illustrating the reception method of FIG. 8;

FIG. 12 illustrates an apparatus for digital broadcast transmission according to another embodiment of the present invention; and

FIG. 13 illustrates an apparatus for digital broadcast reception according to another embodiment of the present invention.

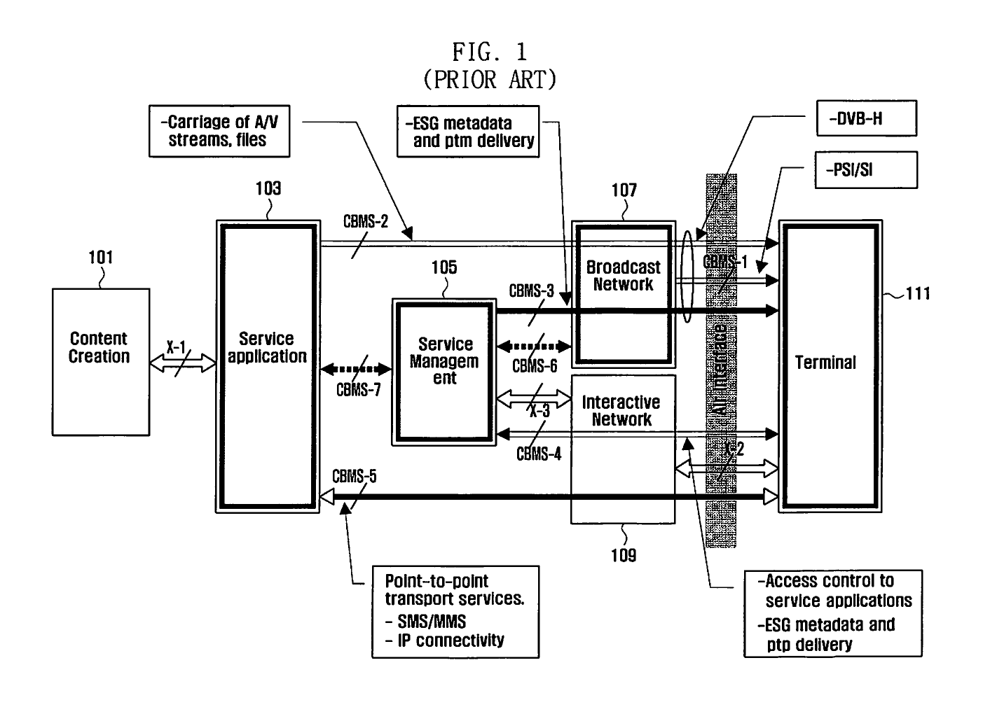

### DETAILED DESCRIPTION OF THE INVENTION

Hereinafter, embodiments of the present invention are described in detail with reference to the accompanying drawings. The same reference symbols are used throughout the drawings to refer to the same or like parts. Detailed descriptions of well-known functions and structures incorporated herein may be omitted to avoid obscuring the subject matter of the present invention.

The present invention relates to providing the same digital broadcast services in multiple formats. A digital broadcast service generally refers to providing content in an audio/video (AV) file format. In the description, a digital broadcast service may refer to providing digital content in any format through digital broadcasting. A digital broadcast service may be related to content in a digital file format. “Digital broadcast service” may be shortened to “service.”

In the description, a digital broadcast transmitter (referred to as a broadcast transmitter and denoted by reference numeral 10) provides services in two or more formats. The broadcast transmitter may correspond to a digital broadcasting network. That is, the broadcast transmitter may correspond to a structure that creates digital broadcast content, configures the content according to broadcasting protocols, and distributes the content through unidirectional and bi-directional wireless networks.

A digital broadcast receiver (referred to as a broadcast receiver and denoted by reference numeral 20) receives services in different formats from the broadcast receiver 20 and plays back one of the received services having an adequate format.

Playing back a digital broadcast service requires reception of an Electronic Service Guide (ESG) carrying information regarding a list of available broadcast services.

In one embodiment, the broadcast transmitter 10 provides an ESG for each format, and the broadcast receiver 20 selects a list of broadcast services having a suitable format for playback on the basis of the ESG. That is, multiple ESGs may be associated with services providing the same content in different formats. Such a specific ESG may be accessed using ESG bootstrap (ESG BS) information present in Program Specific Information/Service Information (PSI/SI).

In the description, two embodiments are provided according to approaches to accessing specific ESGs associated with multiple formats. A first embodiment provides a single piece of ESG BS information, which carries entry points for accessing specific ESGs associated with multiple formats (ESG Entry Points). A second embodiment uses multiple pieces of ESG BS information for different formats, and provides entry points for accessing the ESG BS information (ESG BS entry points). In addition, signaling procedures are provided for the above approaches.

### First Embodiment

In the first embodiment, a service is transmitted and received in SDTV format, and another service is transmitted and received in HDTV format.

In the broadcast network, services in different formats are transmitted through different Transport Streams (TS). For example, an SDTV service may be transmitted through TS1, and an HDTV service may be transmitted through TS2.

In the first embodiment, common ESG information carries ESG entry points for accessing specific ESGs associated with individual formats. For example, an ESG entry point may be used to access a specific ESG for the SDTV service, and another ESG entry point may be used to access a specific ESG for the HDTV service. A service and ESG information associated with the service are transmitted by the same TS. For example, an SDTV service and associated ESG information are carried by TS1, and an HDTV service and associated ESG information are carried by TS2.

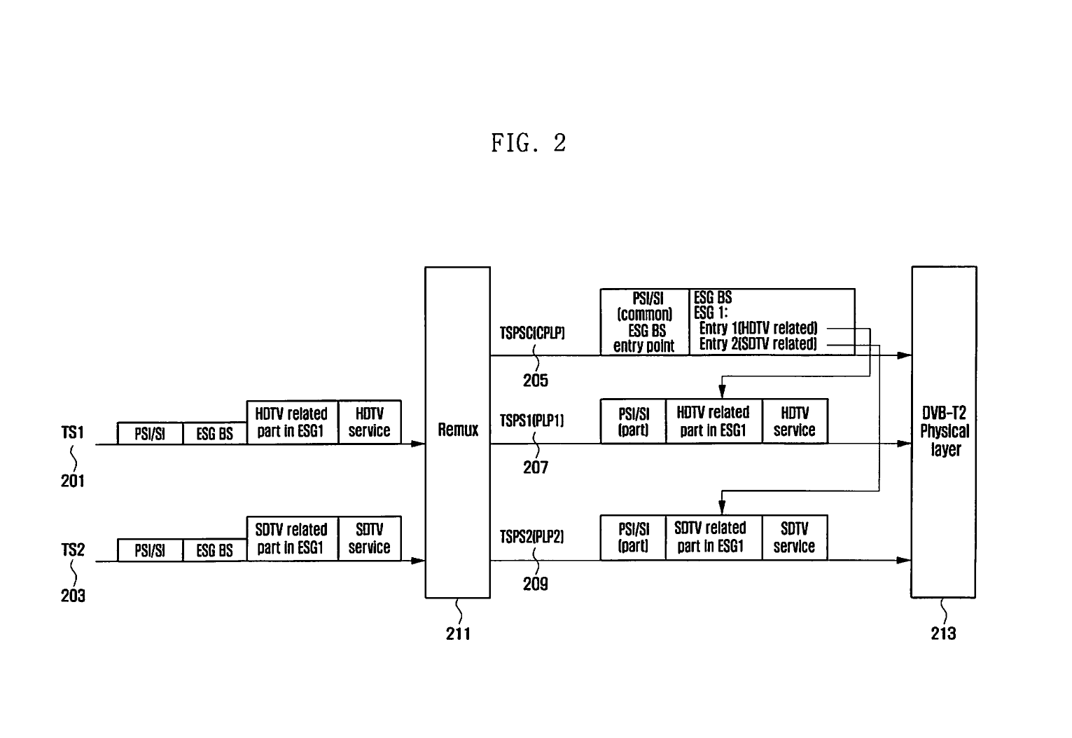

Next, a description is given of digital broadcast transmission. FIG. 2 illustrates a method for digital broadcast transmission according to the first embodiment.

In FIG. 2, services are provided in two formats (HDTV and SDTV). The HDTV and SDTV services are transmitted through two Transport Streams (TS). The two transport streams are reconfigured into three Physical Layer Pipes (PLP) and are transmitted through the DVB-T2 physical layer. The broadcast transmitter 10 may include a remultiplexer 211 for reconfiguring two TSs into three PLPs.

The HDTV service is carried by TS1 201, and the SDTV service is carried by TS2 203. The HDTV-related part of ESG1 is carried by TS1 201, and SDTV-related part of ESG1 is carried by TS2 203. PSI/SI and ESG BS information are commonly carried by TS1 201 and TS2 203.

For effective transmission through the DVB-T2 system, TSs are reconfigured into a group of PLPs. The group of PLPs may include a Common PLP (CPLP) and other PLPs matched respectively with the input TSs.

CPLP 205 carries the transport stream partial stream common (TSPSC), and common PSI/SI and ESG BS information are transmitted by CPLP 205.

Here, the common PSI/SI carries an ESG BS entry point for accessing the ESG bootstrap (ESG BS). Hence, the broadcast receiver 20 may access the ESG bootstrap using the common PSI/SI transmitted through CPLP 205.

The ESG bootstrap carries two ESG entry points for accessing format-related parts of ESG1. ESG entry point-1 is a link to the HDTV-related part of ESG1, which is transmitted through PLP1 207. ESG entry point-2 is a link to the SDTV-related part of ESG1, which is transmitted through PLP2 209.

TSPS1 (Transport Stream Partial Stream 1) is transmitted by PLP1 207. TSPS1 carries a part of PSI/SI related to TS1 201, the HDTV-related part of ESG1 and the HDTV service. TSPS2 is transmitted by PLP2 209. TSPS2 carries a part of PSI/SI related to TS2 203, the SDTV-related part of ESG1 and the SDTV service.

These PLPs 205, 207 and 209 are transmitted through the DVB-T2 physical layer 213.

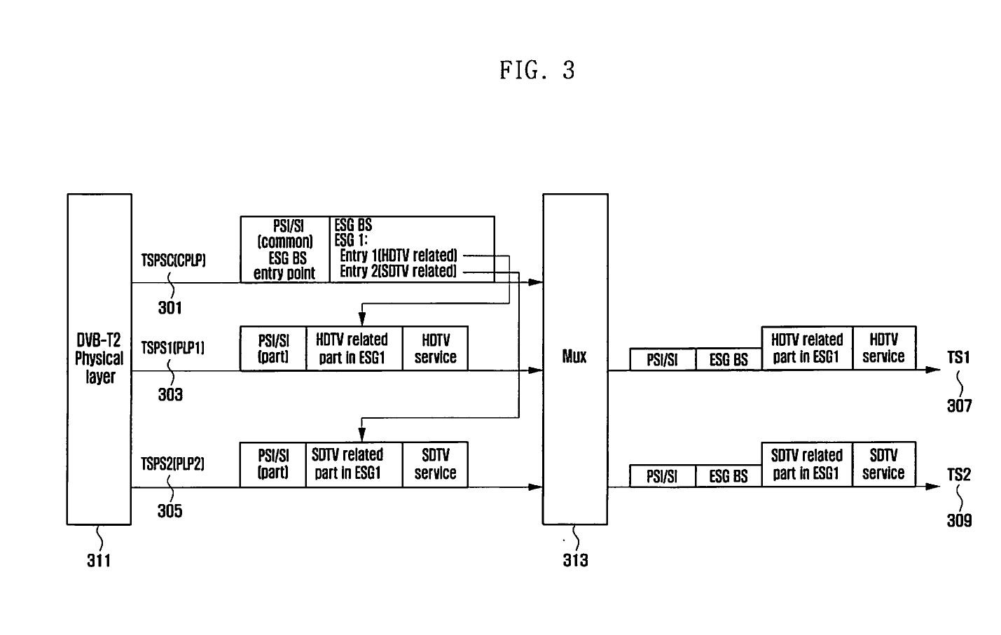

Next, a description is given of digital broadcast reception. FIG. 3 illustrates a method for digital broadcast reception according to the first embodiment.

Referring to FIG. 3, the broadcast receiver 20 receives a group of PLPs through the DVB-T2 physical layer. The broadcast receiver 20 multiplexes the PLPs into TSs associated with individual formats. To achieve this, the broadcast receiver 20 includes a multiplexer 313. The group of PLPs includes one CPLP and multiple PLPs associated with the formats.

For example, the broadcast receiver 20 receives one CPLP 301 and two PLPs 303 and 305 associated with the two formats, and multiplexes PLPs 301, 303 and 305 into two TSs 307 and 309. That is, CPLP 301 and PLP1 303 are multiplexed into TS1 307, and CPLP 301 and PLP2 305 are multiplexed into TS2 309.

The broadcast receiver 20 may obtain common PSI/SI from CPLP 301, and access the ESG bootstrap using an ESG BS entry point present in the common PSI/SI. Here, the ESG BS entry point is carried by the common PSI/SI.

The broadcast receiver 20 may discover two ESG entry points related to ESG1 from the ESG bootstrap. ESG entry point-1 is a link to the HDTV-related part of ESG1, and ESG entry point-2 is a link to the SDTV-related part of ESG1.

Accordingly, the broadcast receiver 20 may multiplex received PLPs 301, 303 and 305 into two TSs 307 and 309.

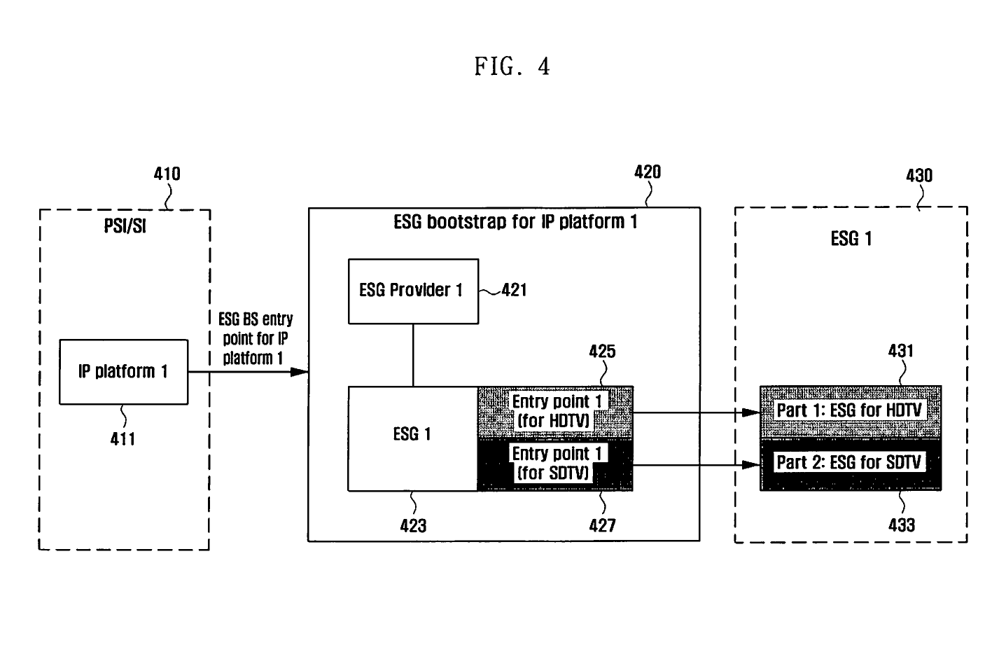

Next, a description is given of signaling for accessing a format-specific ESG. FIG. 4 illustrates a signaling procedure according to the first embodiment.

Referring to FIG. 4, PSI/SI 410 is provided for each IP platform. That is, IP platform 411 is associated with PSI/SI signaling. PSI/SI signals the ESG BS entry point. In other words, a piece of PSI/SI provides an ESG BS entry point in a particular IP platform.

The broadcast receiver 20 may access ESG BS 420 using the ESG BS entry point. ESG BS 420 includes ESG provider 421 and ESG entry points 425 and 427 associated with format-specific services.

For example, ESG1 430 includes service-related parts 431 and 433, and ESG entry points 425 and 427 provide links respectively to service-related parts 431 and 433.

More specifically, ESG1 430 includes two pieces of information. One is part 431 related to the HDTV service, and another is part 433 related to the SDTV service. ESG BS 420 includes different entry points for accessing parts 431 and 433. That is, the ESG BS 420 includes ESG entry points 425 and 427 related to the HDTV and SDTV services.

Hence, the broadcast receiver 20 may access the HDTV-related part of ESG1 using ESG entry point-1 425, and may access the SDTV-related part of ESG1 using ESG entry point-2 427.

To realize the scheme described above, a field named “ServiceFormat” is added to the ESG Access descriptor to specify the service format accessible using the present entry point. This information is referred to as “entry information”.

Entry information is described in Table 1 and Table 2.

TABLE 1
Syntax

ESGEntry {

ESGEntryVersion
ESGEntryLength
AccessPointID
ServiceFormat
descriptor( )

}

TABLE 2

| Field | Semantics |
|---|---|
| n_o_ESGEntries | Specifies the number of ESGEntries in which access |
| | information to ESGs is signalled. |
| ESGEntryVersion | The ESGEntryVersion shall be “2” for the |
| | ESGAccessDescriptor as specified in this document. |
| ESGEntryLength | The EntryLength specifies the length of the ESGEntry |
| | in Bytes excluding the ESGEntryVersion and |
| | EntryLength fields. |
| AccessPointID | The identifier of the accessPoint in the |
| | ESGAccessDescriptor. This is referenced from the |
| | ProviderDiscovery Descriptor for a given ESG. |
| | The accessPointID is unique within the |
| | AccessDescriptor. |
| ServiceFormat | Specifies the service format using this entry point, |
| | e.g. |
| | 0x01: SDTV |
| | 0x02: HDTV |
| | Others: reserved |

Referring to Table 2, the entry information includes the following fields: n_o_ESGEntries, ESGEntryVersion, ESGEntryLength, AccessPointID, and ServiceFormat.

The n_o_ESGEntries field specifies the number of ESG entries in which access information to ESGs is signaled.

The ESGEntryVersion field indicates the version of the ESG entry, and may be set to a specific version according to an embodiment of the present invention.

The ESGEntryLength field specifies the length of the ESGEntry in bytes, excluding the ESGEntryVersion and EntryLength fields.

The AccessPointID field indicates the identifier of the accessPoint in the ESGAccessDescriptor, and is referenced from the ProviderDiscovery Descriptor for a given ESG. The accessPointID is unique within the AccessDescriptor.

The ServiceFormat field specifies the service format used in the ESG entry point, and may be set to ‘0x01’ for the SDTV service and to ‘0x02’ for the HDTV service.

Using the entry information, obtained by adding the ServiceFormat field to the existing ESG Access descriptor, the broadcast receiver 20 may be aware of the format associated with an ESG pointed by each ESG entry point. Hence, the broadcast receiver 20 may select a suitable ESG entry point to access a desired format-related part of ESG.

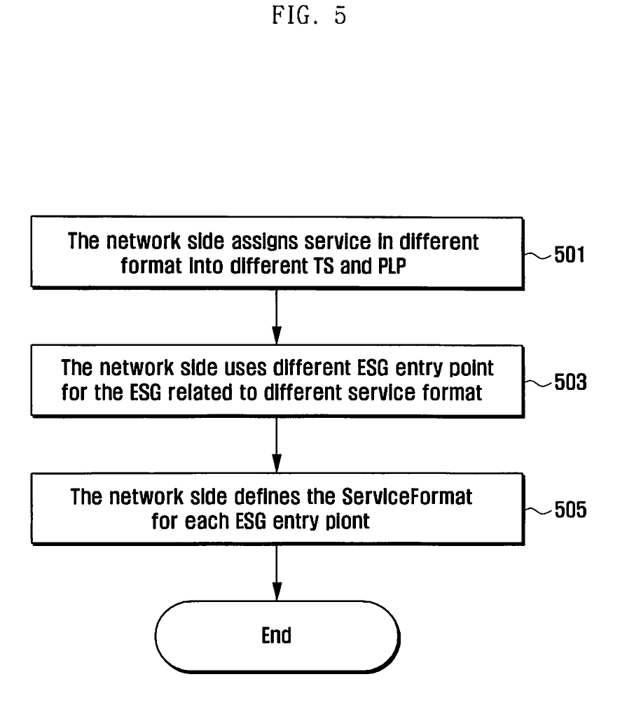

Next, a description is given of the method for digital broadcast transmission, which provides both services in different formats and entry information for accessing a service having a desired format. FIG. 5 is a flow chart illustrating the method for digital broadcast transmission performed by the broadcast transmitter 10.

Referring to FIG. 5, the broadcast transmitter 10 assigns services in different formats to different TSs and PLPs in step 501.

The broadcast transmitter 10 creates ESG entry points associated with ESGs specific to the services in step 503.

The broadcast transmitter 10 composes entry information in step 505. As described before, the entry information indicates the service format associated with each ESG entry point.

Thereafter, the broadcast transmitter 10 broadcasts the services in different formats, an ESG having ESG entry points associated with the services, and ESG entry information.

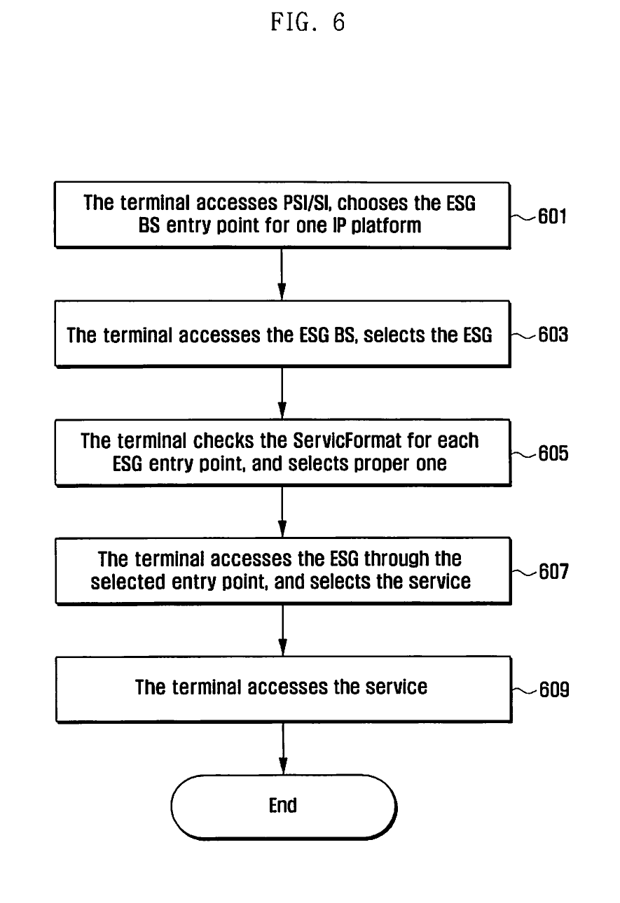

Next, a description is given of the method for digital broadcast reception. FIG. 6 is a flow chart illustrating the method for digital broadcast reception.

Referring to FIG. 6, the broadcast receiver 20 receives a digital broadcast. The digital broadcast may include services in different formats, an ESG having ESG entry points associated with the services, and ESG entry information.

Upon broadcast reception, the broadcast receiver 20 accesses PSI/SI, and selects an ESG BS entry point for a given IP platform in step 601.

The broadcast receiver 20 accesses the ESG BS, and selects the ESG in step 603.

The broadcast receiver 20 accesses entry information (Table 1 and Table 2) containing the service format field, and selects an ESG entry point associated with a desired format in step 605. The broadcast receiver 20 may be aware of the format associated with each ESG entry point by checking the service format field. For example, the broadcast receiver 20 supporting HDTV may select an entry point associated with the HDTV service.

The broadcast receiver 20 accesses the ESG using the selected ESG entry point, selects the service in step 607, and accesses the service in step 609.

As described above, in the first embodiment, ESG entry points are provided for services in different formats. The broadcast receiver 20 may access a suitable service on the basis of entry information carrying ESG entry points.

### Second Embodiment

Like the first embodiment, the second embodiment is related to providing the same digital broadcast services in multiple formats. In the second embodiment, broadcast services are provided in different screen resolutions. This may be effectively applied to both a mobile broadcast receiver having a small screen resolution and a fixed broadcast receiver having a large screen resolution.

In the second embodiment, services may be provided in different screen resolutions. For example, a service with a small screen resolution and another service with a large screen resolution may be transmitted by different transport streams. In particular, ESG BS entry points are provided respectively to services with different screen resolutions. For example, one ESG BS entry point may be associated with a service with a small screen resolution, and another ESG BS entry point may be associated with a service with a large screen resolution.

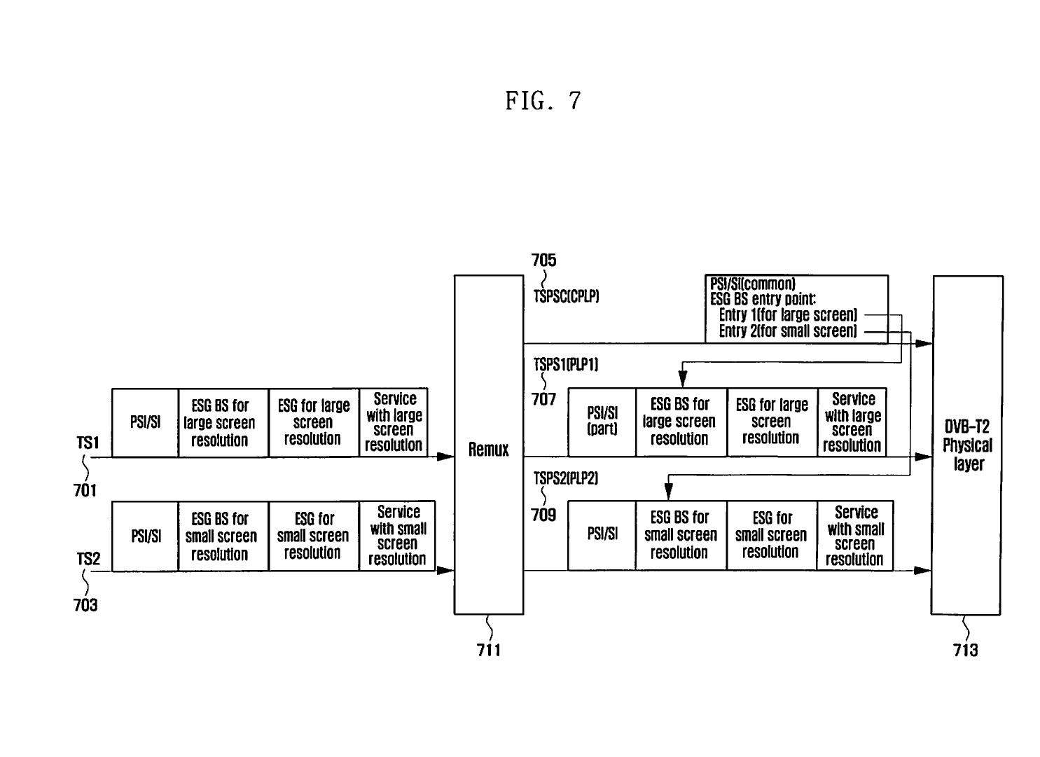

Next, a description is given of digital broadcast transmission. FIG. 7 illustrates a method for digital broadcast transmission according to the second embodiment.

In FIG. 7, it is assumed that broadcast services are provided in small and large screen resolutions. The small and large screen resolution services are transmitted through two TSs 701 and 703. The two TSs 701 and 703 are reconfigured into three PLPs 705, 707 and 709 and are transmitted through the DVB-T2 physical layer. The broadcast transmitter 10 may include a remultiplexer 711 for reconfiguring two TSs 701 and 703 into three PLPs 705, 707 and 709.

A service with a given screen resolution and an ESG associated with the service are transmitted by the same TS. The large screen resolution service and the associated ESG are transmitted by TS1 701, and the small screen resolution service and the associated ESG are transmitted by TS2 703.

Like the first embodiment, PSI/SI is commonly carried by TS1 701 and TS2 703. Unlike the first embodiment, however, different ESG BSs are carried by TS1 701 and TS2 703. That is, ESG BS associated with the large screen resolution service is carried by TS1 701, and ESG BS associated with the small screen resolution service is carried by TS2 703.

For effective transmission through the DVB-T2 system, TSs are reconfigured into a group of PLPs. The group of PLPs may include a common PLP (CPLP) and other PLPs matched respectively with the input TSs.

CPLP 705 carries the transport stream partial stream common (TSPSC), and common PSI/SI is transmitted by CPLP 705. Here, PSI/SI carries two ESG BS entry points.

ESG BS entry point-1 is a link to ESG BS specific to the large screen resolution, and the ESG BS is transmitted through PLP1 707. ESG BS entry point-2 is a link to ESG BS specific to the small screen resolution, and the ESG BS is transmitted through PLP2 709.

TSPS1 is transmitted by PLP1 707. TSPS1 carries a part of PSI/SI related to TS1 701, ESG BS specific to the large screen resolution, ESG specific to the large screen resolution and the large screen resolution service.

TSPS2 is transmitted by PLP2 709. TSPS2 carries a part of PSI/SI related to TS2 703, ESG BS specific to the small screen resolution, ESG specific to the small screen resolution and the small screen resolution service.

These PLPs 705, 707 and 709 are transmitted through the DVB-T2 physical layer 713.

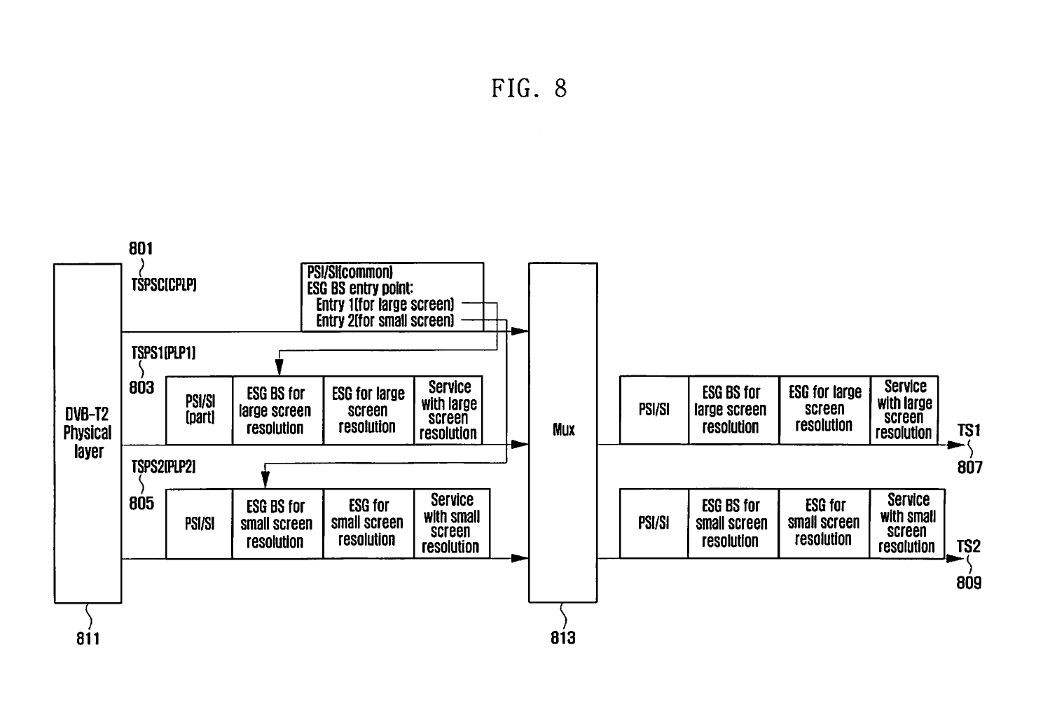

Next, a description is given of digital broadcast reception. FIG. 8 illustrates a method for digital broadcast reception according to the second embodiment.

Referring to FIG. 8, the broadcast receiver 20 receives a group of PLPs through the DVB-T2 physical layer. The broadcast receiver 20 multiplexes the PLPs into TSs associated with screen resolutions. To achieve this, the broadcast receiver 20 includes a multiplexer 813. The group of PLPs includes one CPLP and multiple PLPs associated with the screen resolutions.

For example, the broadcast receiver 20 receives one CPLP 801 and two PLPs 803 and 805 associated with the screen resolutions, and multiplexes PLPs 801, 803 and 805 into two TSs 807 and 809. That is, CPLP 801 and PLP1 803 are multiplexed into TS1 807, and CPLP 801 and PLP2 805 are multiplexed into TS2 809.

Common PSI/SI includes ESG BS entry points related to two screen resolutions. That is, common PSI/SI includes ESG BS entry points specific to large and small screen resolutions.

Hence, the broadcast receiver 20 may access ESG BS specific to a desired screen resolution from the common PSI/SI, access ESG through the ESG BS, and select and access a service through the ESG.

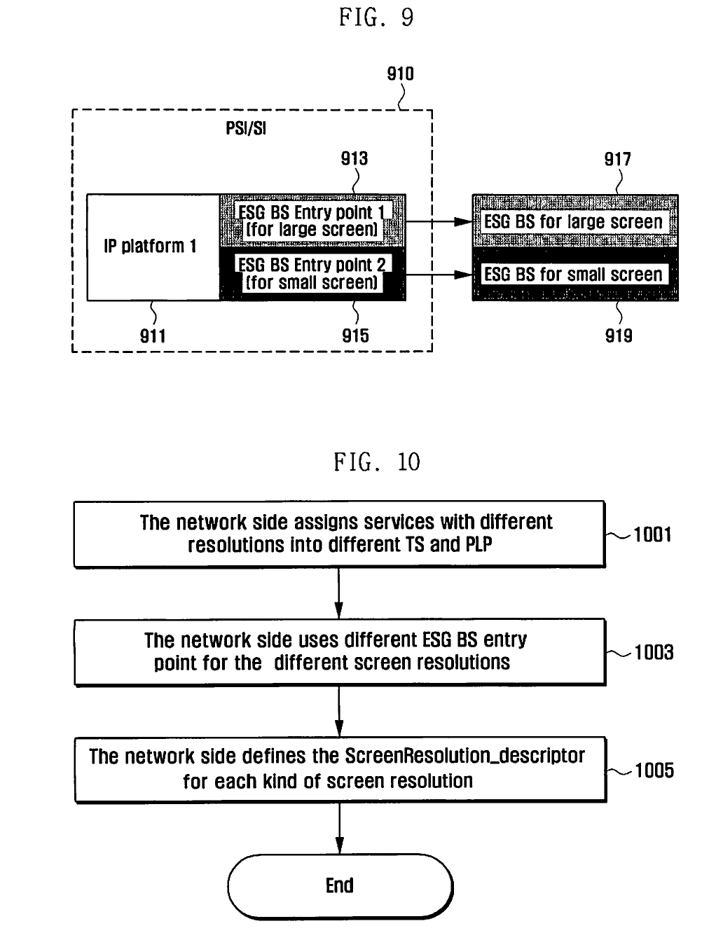

Next, a description is given of signaling for accessing a format-specific ESG. FIG. 9 illustrates a signaling procedure according to the second embodiment.

Referring to FIG. 9, PSI/SI 910 is provided for each IP platform. That is, IP platform 911 is associated with PSI/SI signaling. IP platform 911 has multiple ESG BS entry points for accessing ESG BSs specific to different screen resolutions.

In IP platform 911, PSI/SI provides ESG BS entry points 913 and 915 specific to large and small screen resolutions. Here, the ESG BS entry point 913 refers to ESG BS 917 specific to the large screen resolution, and the ESG BS entry point 915 refers to ESG BS 919 specific to the small screen resolution.

In the second embodiment, one ESG BS entry point is present for each screen resolution (format). In addition, “entry information” includes information identifying the screen resolution indicated by each ESG BS entry point, and access information to each ESG BS.

Table 3 describes entry information according to the second embodiment.

TABLE 3
IP/MAC_notification_section{

Platform_id
target_descriptor_loop( )
target_ip_slash_descriptor( ) => IP address for the ESG bootstrap
ScreenResolution_descriptor( ) => specify which screen resolution is

used for this entry
point

operational_descriptor_loop( )

}

In the second embodiment, the entry information is transmitted by the IP/MAC notification section in PSI/SI, and the IP/MAC notification section provides information specific to a particular IP platform. Here, “Platform_id” identifies the IP platform, “Target_ip_slash_descriptor” signals the IP address of ESG BS, and newly added “ScreenResolution_descriptor” specifies the screen resolution indicated by the ESG BS entry point.

Using the entry information, the broadcast receiver 20 may be aware of an ESG BS entry point specific to a service with a particular screen resolution. Hence, the broadcast receiver 20 may select an ESG BS entry point suitable to a desired screen resolution.

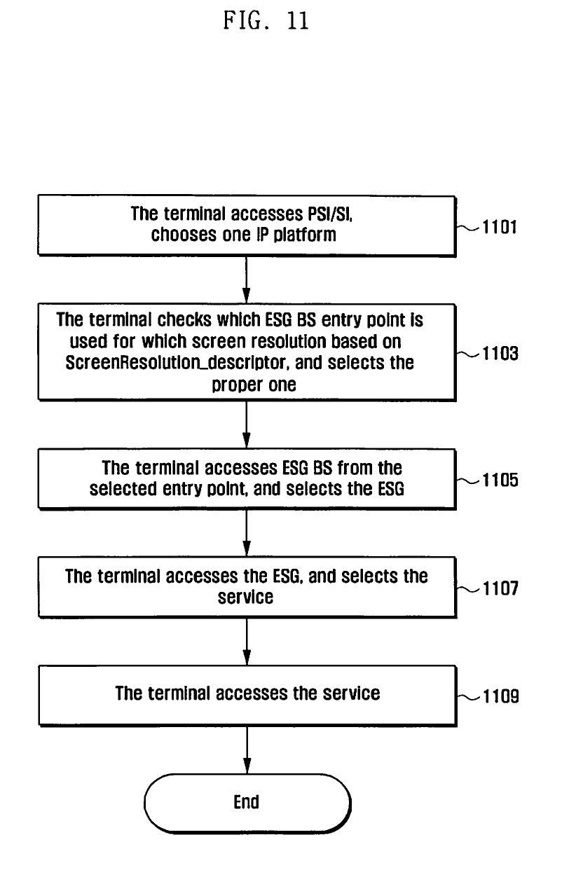

Next, a description is given of the method for digital broadcast transmission, which provides both services in different formats and entry information for accessing a service with a desired format. FIG. 10 is a flow chart illustrating the method for digital broadcast transmission according to the second embodiment.

Referring to FIG. 10, the broadcast transmitter 10 assigns services in different formats to different TSs and PLPs in step 1001. That is, the broadcast transmitter 10 assigns services with different screen resolutions to different TSs and PLPs.

The broadcast transmitter 10 creates ESG BS entry points specific to the services with different screen resolutions in step 1003.

The broadcast transmitter 10 composes entry information indicating the screen resolution associated with each ESG BS entry point in step 1005.

Thereafter, the broadcast transmitter 10 broadcasts the services in different formats, ESG BS entry points associated with the services, and entry information.

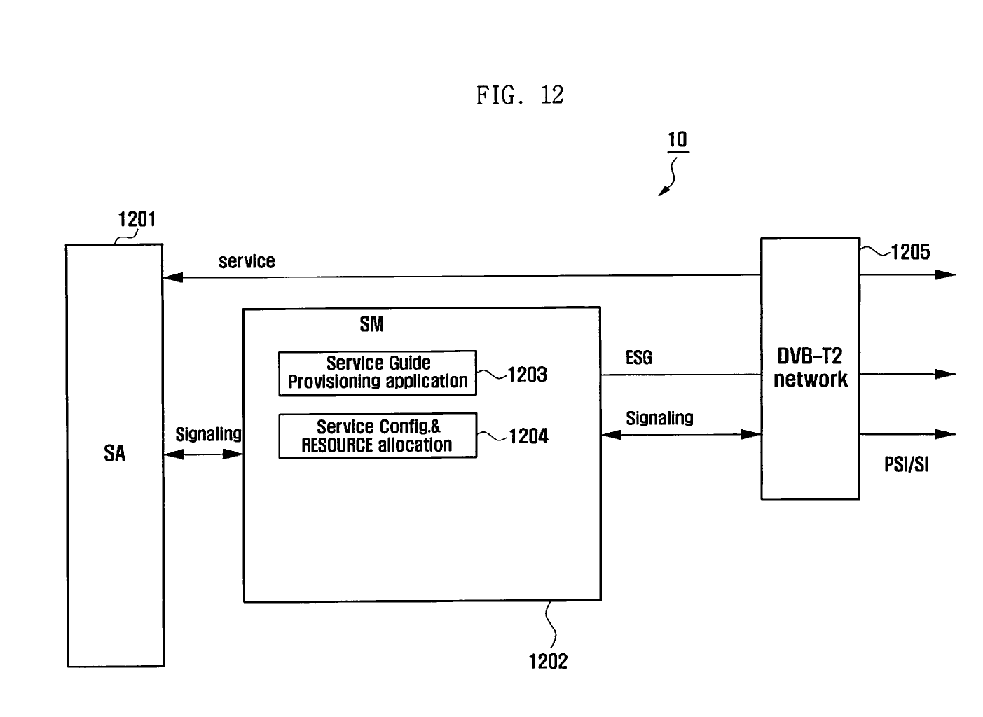

Next, a description is given of the method for digital broadcast reception. FIG. 11 is a flow chart illustrating the method for digital broadcast reception according to the second embodiment.

Referring to FIG. 11, the broadcast receiver 20 receives a digital broadcast. The digital broadcast may include services in different formats, ESG BS entry points associated with the services, and entry information.

Upon broadcast reception, the broadcast receiver 20 accesses PSI/SI, and selects an IP platform in step 1101.

The broadcast receiver 20 checks ESG BS entry points using the IP platform, and selects the ESG BS entry point specific to a desired screen resolution in step 1103. The broadcast receiver 20 may be aware of the screen resolution associated with each ESG BS entry point by checking the entry information. As described in connection with Table 3, the entry information includes “ScreenResolution_descriptor”, which signals the screen resolution related to the ESG BS entry point.

The broadcast receiver 20 accesses the ESG BS using the selected ESG BS entry point, and selects the associated ESG in step 1105. The broadcast receiver 20 accesses the ESG and selects the service in step 1107, and accesses the selected service in step 1109.

As described above, HDTV and SDTV television formats are used as service formats in the first embodiment, and small and large screen resolutions are used as service formats in the second embodiment. However, the present invention is not limited thereto, and television formats and screen resolutions may be used together. For example, an HDTV service or SDTV service may be provided in small and large screen resolutions.

FIG. 12 illustrates the configuration of the broadcast transmitter 10.

Referring to FIG. 12, the broadcast transmitter 10 may include Service Application (SA) 1201, Service Management (SM) 1202, and DVB-T2 Network 1205. Service Management 1202 includes, as sub-entities, Service Guide Provisioning Application 1203 and Service Configuration and Resource Allocation 1204.

Service Application 1201 aggregates content and related metadata from multiple sources in order to provide a particular service application.

Service Management 1202 may be composed of several sub-entities for management.

Service Guide Provisioning Application 1203 aggregates ESG or metadata from service applications.

Service Configuration and Resource Allocation 1204 registers service applications according to bands of a broadcast bearer. For example, Service Configuration and Resource Allocation 1204 may assign a DVB-H IP platform to each DVB TS, and may specify a location, band and schedule for a service.

DVB-T2 Network 1205 transmits a service, ESG information, and PSI/SI.

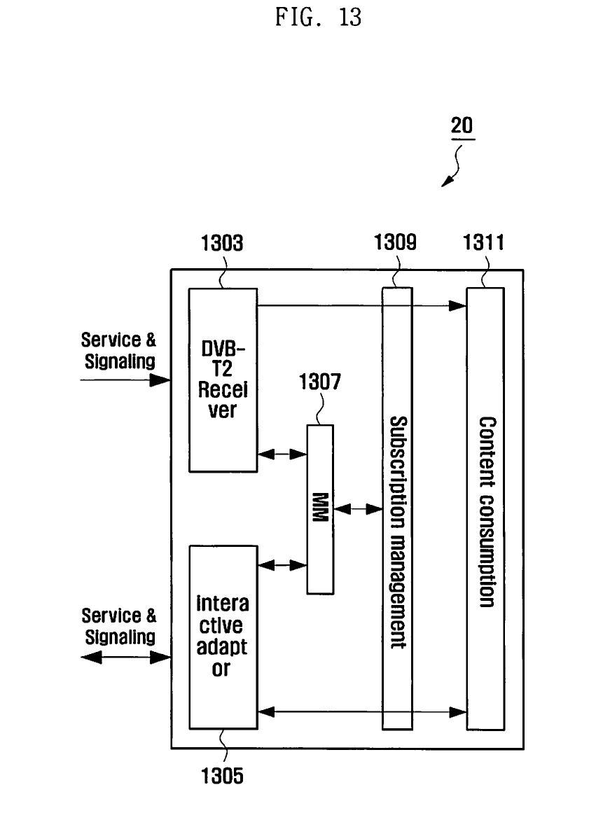

FIG. 13 illustrates the configuration of the broadcast receiver 20.

Referring to FIG. 13, the broadcast receiver 20 may include DVB-T2 Receiver 1303, Interactive Adaptor 1305, Mobility Management (MM) 1307, Subscription Management 1309, and Content Consumption 1311.

DVB-T2 Receiver 1303 receives a service and signaling data through a broadcast network.

Interactive Adaptor 1305 receives a service and signaling data through an interactive network.

Mobility Management MM 1307 manages handover and roaming through the broadcast network and interactive network.

Subscription Management 1309 performs management operations related to license acquisition and maintenance, and content decoding. For example, as to content encrypted for Digital Rights Management (DRM) or a Conditional Access System (CAS), Subscription Management 1309 may acquire a license for the content and decode the content using the acquired license.

Content Consumption 1311 consumes a service. For example, as to a video service, Content Consumption 1311 may play back video data of the service for user viewing.

Although embodiments of the present invention have been described in detail hereinabove, it should be understood that many variations and modifications of the basic inventive concept herein described, which may appear to those skilled in the art, will still fall within the spirit and scope of the embodiments of the present invention as defined in the appended claims.

What is claimed is:

1. A method of transmitting multi-format digital broadcasts, comprising:
creating digital broadcast services having different formats and Electronic Service Guides (ESG) associated with the digital broadcast services;
creating entry information for accessing the ESGs; and
transmitting the digital broadcast services, the ESGs, and the entry information.

2. The method of claim 1, wherein the entry information contains links referring to the ESGs.

3. The method of claim 1, further comprising transmitting ESG Bootstraps (ESG BS) associated with the ESGs, and wherein the entry information contains ESG BS entry points as links referring to the ESG BSs.

4. The method of claim 1, wherein the digital broadcast services comprise a high definition television (HDTV) service and a standard definition television (SDTV) service.

5. A method of receiving multi-format digital broadcasts, comprising:
receiving digital broadcast services having different formats, Electronic Service Guides (ESGs) associated with the digital broadcast services, and entry information for accessing the ESGs;
selecting one of the ESGs associated with a desired format utilizing the received entry information; and
playing back one of the digital broadcast services associated with the selected ESG.

6. The method of claim 5, wherein the entry information contains links referring to the ESGs.

7. The method of claim 5, further comprising receiving ESG Bootstraps (ESG BS) associated with the ESGs, and wherein the entry information contains ESG BS entry points as links referring to the ESG BSs.

8. The method of claim 5, wherein the digital broadcast services comprise a high definition television (HDTV) service and a standard definition television (SDTV) service.

9. An apparatus for transmitting multi-format digital broadcasts, comprising:
a service guide provisioning application creating digital broadcast services having different formats, creating Electronic Service Guides (ESG) associated with the digital broadcast services, and creating entry information for accessing the ESGs; and
a communication means transmitting the digital broadcast services, the ESGs, and the entry information.

10. The apparatus of claim 9, wherein the entry information contains links referring to the ESGs.

11. The apparatus of claim 9, wherein the communication means transmits ESG Bootstraps (ESG BS) associated with the ESGs, and wherein the entry information contains ESG BS entry points as links referring to the ESG BSs.

12. The apparatus of claim 9, wherein the digital broadcast services comprise a high definition television (HDTV) service and a standard definition television (SDTV) service.

13. An apparatus for receiving multi-format digital broadcasts, comprising:
a receiver receiving digital broadcast services having different formats, Electronic Service Guides (ESGs) associated with the digital broadcast services, and entry information for accessing the ESGs; and
a content consumption unit selecting one of the ESGs associated with a desired format utilizing the received entry information, and playing back one of the digital broadcast services associated with the selected ESG.

14. The apparatus of claim 13, wherein the entry information contains links referring to the ESGs.

15. The apparatus of claim 13, wherein the receiver receives ESG Bootstraps (ESG BS) associated with the ESGs, and wherein the entry information contains ESG BS entry points as links referring to the ESG BSs.

16. The apparatus of claim 13, wherein the digital broadcast services comprise a high definition television (HDTV) service and a standard definition television (SDTV) service.
